(19) United States
(12) Patent Application Publication
(10) Pub. No.: US 2021/0209628 A1
(43) Pub. Date: Jul. 8, 2021

(54) System and Method of Interactive Voting and Identity Verification

(71) Applicants: Aminu Bamali, Garki Abuja (NG); Umar Ladan-Baki, Kaduna (NG)

(72) Inventors: Aminu Bamali, Garki Abuja (NG); Umar Ladan-Baki, Kaduna (NG)

(21) Appl. No.: 16/330,391

(22) PCT Filed: Sep. 1, 2017
(86) PCT No.: PCT/IB2017/055283

§ 371 Date: Mar. 5, 2019

(30) Foreign Application Priority Data
Sep. 5, 2016 (NG) NG/P/2016/000283

(51) Int. Cl. G06Q 30/02; G06Q 50/00; G06F 21/32; G06Q 20/36

(52) U.S. Cl. CPC G06Q 30/0203; G06Q 50/01; G06Q 2230/00; G06Q 20/3672; G06Q 30/0271; G06F 21/32

(57) ABSTRACT

A method of providing verified user communication includes: storing data received from a user corresponding to a voting user account; verifying an identity of the user using one of biometrics; as well as, background authentication, and photo identification of the user; storing data received form a user corresponding to a representative user account; verifying an identity of the representative user; polling voting users based on a poll displayed to the voting users and receiving a vote from the voting users if the voting user is verified; and facilitating communication between voting user accounts and representative user accounts.

### CROSS-REFERENCE TO RELATED APPLICATION

This application claims priority to Nigerian Patent Application No. NG/P/2016/000283 entitled “Truevoix” on Sep. 5, 2016, the contents of which are hereby incorporated by reference in its entirety.

### FIELD

This disclosure relates to a mobile phone or web based system that allows users to participate in the democratic process of their respective countries wherever they are around the globe & optionally observe those of other countries.

### BACKGROUND

Social media technology allows users to engage one another on issues ranging from personal issues to broader social and societal issues. However, existing systems do not verify an identity of its users and therefore allows users to create multiple or fraudulent accounts. Further, existing systems do not promote communication between users and public representatives.

What is needed, therefore, is a system that allows users to participate in the democratic process of their respective countries wherever they are around the globe & optionally observe those of other countries.

### SUMMARY

The above and other needs are met by a system and method of interactive voting and identity verification. In a first aspect, a method of providing verified user communication includes: storing data received from a user corresponding to a voting user account; verifying an identity of the user using one of biometrics, background authentication, and photo identification of the user; storing data received form a user corresponding to a representative user account; verifying an identity of the representative user; polling voting users based on a poll displayed to the voting users and receiving a vote from the voting users if the voting user is verified; and facilitating communication between voting user accounts and representative user accounts.

In one embodiment, the method further includes verifying that new users are previously unregistered with a database of existing user before assigning one of a user ID and unique barcode to the user.

In another embodiment, the method further includes uniquely identifying users and ensuring one user has only one account regardless of a number of mobile devices owned by the user.

In yet another embodiment, the method further includes verifying an identity of a user with one of social media and peer to peer interactions.

In one embodiment, the method further includes sending messages directly to targeted individuals to ensure the individual is not a fake account.

In another embodiment, the method further includes authenticating and verifying real users logged into other accounts to ensure that users of other accounts are interacting with real individuals to prevent impersonation.

In yet another embodiment, the method further includes uniquely identifying citizens by law authorities.

In one embodiment, the method further includes uniquely identifying traveling passengers using the method of claim 1.

In another embodiment, the method further includes ensuring market surveys and advertising are performed with real individuals according to respective demographics of the individuals.

In yet another embodiment, the method further includes identifying users uniquely through the voting user account to access medical and insurance information without recourse to the user's hospitals, cards, or other conventional means.

In a second aspect, a method of providing verified user communication includes: storing data received from a user corresponding to a voting user account; engaging in virtual townhall meetings for discussions pertinent to uniquely identified constituents of particular locations; storing data received form a user corresponding to a representative user account; verifying an identity of the user using one of biometrics, background authentication, and photo identification of the user; polling voting users based on a poll displayed to the voting users and receiving a vote from the voting users if the voting user is verified; and facilitating communication between voting user accounts and representative user accounts.

In one embodiment, the method further includes accurately determining input and public opinion of a particular constituency on any particular issue by uniquely identifying each user.

In another embodiment, the method further includes identifying and predicting potential leaders from a popularity of authentic ratings of inputs on public and national issues.

In yet another embodiment, the method further includes polling larger groups of individuals to collect additional data than currently provided by population sampling over the internet.

In one embodiment, the method further includes authenticating a collective satisfaction of constituents based on elected representatives.

In another embodiment, the method further includes identifying account holders to access account holder transactions with merchants to gain loyalty rewards without cards.

In yet another embodiment, the method further includes verification of customers at merchants prior to consummation of financial transactions and accessing online payment platforms without using cards or mobile devices.

In one embodiment, the method further includes accessing all financial and identity information of customers using the voting user account to enable conducting of transactions and self identification without recourse to cards and registered mobile devices.

In another embodiment, the method further includes preventing credit card fraud by uniquely identifying card holders at a point of sale using the voting user account.

In a third aspect, a method is provided for uniquely identifying parties in crypto currency transactions that satisfies information collection requirements of Financial Sector Regulators and fulfills Anti-Money Laundering and Combating the Financing of Terrorism (AML/CFT) requirements; using the voting user account of claim 1 without using registered mobile devices.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

A system and method of interactive voting and identity verification provides an authentic polling system and a social media platform for people to present their views on pertinent issues relating to their lives, as well as fun stuff, socializing and getting access to Government Services. Also, they can send text or audio-visual messages to other users and to their political representatives.

The system and method of the present disclosure provides a medium where all desirous citizens can have regular, recorded, and interactive discussions. Users may also have their opinions taken on certain relevant issues. The system and method of this disclosure will produce regular reports for informing the public about members' opinions and most popular comments or suggestions on the most significant topics.

Questions that voters will be asked can be created by the Administrators of the app or be generated by users; and the most liked questions will be the most popular questions of the week that will be surveyed or polled.

A social networking feature will allow for further discussions of issues and recommendations to policy makers.

A forum will also allow users an option of choosing comments they like, so the most popular comments are highlighted. Putting a ranking feature on the popular comments will allow for membership recognition for their input and positive contributions. This will also make it easier to pick out leaders from the youth.

Voting for Nationals outside their countries can be carried out via the app, with verification of their identities via their embassies and/or verification of their identities by unique ID by the app Admin.

Reports of the polls, most popular comments and recommendations and ratings of representatives will be published on the app home page regularly.

The app uses data analytic tools to interface with the databases of unique identifiers used (such as biometrics and National IDs) to ensure that a user is only registered once.

### User Functions

Users will be able to view home screen.

Users will be able to sign up/login in the system.

Users will be able to create their profile with profile picture, name, address and can submit Unique Identity number (like Driver License, Voter ID no, etc) or biometrics for registration.

Users will be able to browse topics under different categories in the system.

Users will be able to view topic information and description and can comment on the topic in the system.

Users will be able to like on the comment given by the other users in the system.

Users comment will be highlighted based on the no of likes received in the system.

Users will be able to browse polls or surveys in the system.

Users will be able to submit issues which they want to raise and after admin approval it will be listed in the system.

Users will be able to submit their vote in the poll in the system.

Users will be able to submit their views like in favor or not in favor for the issues raised by other users in the system.

Users will be able to view Users different representatives profile in the system.

Users will be able to follow the particular representative in the system.

Representative will also be able to login in the app by using the credentials provided by the Admin from the backend on their email address.

Representative will be able to create their profile with profile picture, name, address etc.

Users will be able to post issue by uploading or shooting the video in the system. They will be able to submit the location/area in the system.

Representative will be able to view video issue posted in their area/location and can respond to that issue by uploading the video or by texting.

Admin will be able to first review the video issue then it will go live after admin approval.

Other users will also be able to discuss on that issue and like the comment of the representative in the system. Other users will only discuss on text basis.

Users will be able to share the content to the social networking platform like Facebook, Twitter, etc in the system.

Users will be able to view Google Ads in the system.

Users will be able to contact with the Admin by submitting the contact us form in the system.

App will Auto detect the obscene or inappropriate language.

Admin will be able to post the document or video for the issues posted by the user in the app, user can view the video or document posted by the admin for their issues in the app.

### Notifications

Users will receive a notification after registration.

Users will be able to receive a notification after their issues has been viewed by other users.

Admin will be able to upload all the video over YouTube Channel directly from the web backend.

### Administrative Panel

A back end of the website will be power packed with an administrative panel to manage the updates of data at the apps. Following are the key functionalities:

Users Management: Admin will be able to manage the users of the site. Admin will be able to Add/Delete users of the site. Admin will be able to view the list of all users of the site. Admin will be able to Search the list of all users of the site. Admin will be able to Activate or deactivate the account of the users on the site.

Topics Management: Admin will be able to manage the Categories of topics on the website. Admin will be able to add/Edit/Delete the Categories of topics with codes on the website. Admin will be able to view the list of all Categories of topics of the website. Admin will be able to Activate/Deactivate the Categories of topics of the website. Admin will be able to add/Edit/Delete topics on the website.

General Management: Manage Polls.

Manage Sub-Admin: Manage Video Issues. Manage Representative. Manage Discussion on Issues.

Application Structure:

| The sections in the app will | | | |
|---|---|---|---|
| be arranged as follows, this | | | |
| also represents the top level | | | |
| navigation that would be accessible | Section (Top | | Links under this |
| throughout the portal: s/n | Level Navigation) | Remarks | section/Features |
| 1 | Home Page | Landing Page for the | Top Level Navigation |
| | | application. Links to all | |
| | | sections and selected | |
| | | content from other pages | |
| | | are shown here. | |
| 2 | Surveys/Polls Page | Section that allows | Categories of Interests |
| | | members to raise questions | Most popular questions |
| | | or issues that they want | Voting on questions/issues |
| | | surveys or polls on. | Voting choices |
| 3 | Social | Forums and Message | Join the discussion |
| | Network/Forum/Blogs | boards for Interactive | Follow the discussion |
| | | discussion on Issues and | Vote on comments |
| | | suggestions. Blogs for | |
| | | writers. | |
| 4 | Talk to your rep feature | Chat & Video Recording | Message sending |
| | | feature to transmit text and | Message receipt, and |
| | | audio-visual messages to | Representative rating |
| | | representatives and receipt | feature. |
| | | of similar responses. | |
| 5 | Messages | Section that allows the | Optionally receive |
| | | receipt of sponsored audio | messages from Third |
| | | visual messages | party sponsors |
| 6 | Other Features | Will contain revenue | Job bank |
| | | generating features. | Business Directory |
| | | | Online Price Comparison |
| | | | Sponsored Surveys |

System Content Page: Home Screen; Sign up/Login; View Topics; Topic Information; Comment on Topic and View Other Users Comment; Like on the Comment Given by other Users; View Highlighted Comment on the Particular topic based on the no of Likes received; Browse Polls/Surveys under different categories; Submit Issues; Submit Vote on the Poll; Submit Views on the Issues raised by other Users; View Different Representatives; View Particular Representative Profile; View Particular aspiring Representative Profile; View Particular Government Agency/NGO Profile; Follow Representative; Login as Representative; Login as aspiring Representative; Login as Government Organization/NGO; Post Video Issue; View Video Issue raised by the users in their area (by Representative); Respond to Video Issue Raised by the User; Discussion on the Issue; Social Networking Platform; Advertisements; Contact Us.

Benefits of the system and method of the present disclosure include the following:

The encouragement of participation in the democratic process;

Discussing of political issues;

Conducting most authentic electronic referendums, polls & other votes;

For sending and receiving text and audio-visual messages with other users and political representatives;

For receiving messages from third parties, such as NGO's, political organizations, aspiring politicians, etc.;

For providing actual ratings of the satisfaction of the responses of users' political representatives on issues raised to them; thereby enhancing social contract and entrenching democracy

For alternative online registrations—use of the present system to register or log into other electronic accounts;

Voting of Nationals from diaspora;

For conducting individualized customer surveys;

Substitute for international Passports and other Government means of identification;

Identification to get access to Government Services such as healthcare, welfare, pensions, etc.;

Used for impersonation proof social media and other online engagements with others that are also authentically represented;

Safe, impersonation proof peer to peer auctioning and sales.

Allows crypto currencies to be used by commercial banks as legal tender

Enhances Financial inclusion of the under banked

The system and method of the present disclosure provides for teledemocracy and social media. Each member will have to be certified as having only one registration, i.e., you cannot have one person as many members. The system and method of the present disclosure can only register one user once. One user cannot have more than one account.

This is done by registering using biometrics to verify your uniqueness.

The system and method of the present disclosure includes the ability for users to participate in the most authentic manner, as a user is uniquely identified and can only have one account; regardless of how many devices are used to register or login. This ensures that participation or voting is actual; thereby making usage of the present system and method for polling as authentic and genuine as if done personally. The system and method of the present disclosure also informs the public of the level of satisfaction of political representatives by their constituency and thus enhancing Social contract.

Existing systems allow users to register with emails or devices which may enable a user to complete multiple registrations. The system and method of the present disclosure uses biometrice to ensure one user has only one account.

Currently, users of other platforms can have multiple accounts with fake online personalities. The system of the present disclosure ensures that there are no online impersonations.

The system and method of the present disclosure enhances social contract by bringing to the fore effective and ineffective political representatives; according to their constituency.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A method of providing verified user communication comprising:
storing data received from a user corresponding to a voting user account;
verifying an identity of the user using one of biometrics, background authentication, and photo identification of the user;
storing data received form a user corresponding to a representative user account;
verifying an identity of the representative user;
polling voting users based on a poll displayed to the voting users and receiving a vote from the voting users if the voting user is verified; and
facilitating communication between voting user accounts and representative user accounts.

2. The method of claim 1, further comprising verifying that new users are previously unregistered with a database of existing user before assigning one of a user ID and unique barcode to the user.

3. The method of claim 1, further comprising uniquely identifying users and ensuring one use has only one account regardless of a number of mobile devices owned by the user.

4. The method of claim 1, further comprising verifying an identity of a user with one of social media and peer to peer interactions.

5. The method of claim 1, further comprising sending messages directly to targeted individuals to ensure the individual is not a fake account.

6. The method of claim 1, further comprising authenticating and verifying real users logged into other accounts to ensure that users of other accounts are interacting with real individuals to prevent impersonation.

7. The method of claim 1, further comprising uniquely identifying citizens by law authorities.

8. The method of claim 1, further comprising uniquely identifying traveling passengers using the method of claim 1.

9. The method of claim 1, further comprising ensuring market surveys and advertising are performed with real individuals according to respective demographics of the individuals.

10. The method of claim 1, further comprising identifying users uniquely through the voting user account to access medical and insurance information without recourse to the user's hospitals, cards, or other conventional means.

11. A method of providing verified user communication comprising:
storing data received from a user corresponding to a voting user account;
engaging in virtual townhall meetings for discussions pertinent to uniquely identified constituents of particular locations;
storing data received form a user corresponding to a representative user account;
verifying an identity of the user using one of biometrics, background authentication, and photo identification of the user;
polling voting users based on a poll displayed to the voting users and receiving a vote from the voting users if the voting user is verified; and
facilitating communication between voting user accounts and representative user accounts.

12. The method of claim 11, further comprising accurately determining input and public opinion of a particular constituency on any particular issue by uniquely identifying each user.

13. The method of claim 11, further comprising identifying and predicting potential leaders from a popularity of authentic ratings of inputs on public and national issues.

14. The method of claim 11, further comprising polling larger groups of individuals to collect additional data than is provided by traditional population sampling over the internet.

15. The method of claim 11, further comprising authenticating a collective satisfaction of constituents based on elected representatives.

16. The method of claim 1, further comprising identifying account holders to access account holder transactions with merchants to gain loyalty rewards without cards.

17. The method of claim 1, further comprising verification of customers at merchants prior to consummation of financial transactions and accessing online payment platforms without using cards or mobile devices.

18. The method of claim 1, further comprising accessing all financial and identity information of customers using the voting user account to enable conducting of transactions and self identification without recourse to cards and registered mobile devices.

19. The method of claim 1, further comprising preventing credit card fraud by uniquely identifying card holders at a point of sale using the voting user account.

20. The method of claim 1, further comprising conducting financial transactions using only the voting user accounts without registered mobile devices, cards, and paper money to enhance financial inclusion.

21. A method for uniquely identifying parties in crypto currency transactions that satisfies information collection requirements of Financial Sector Regulators and fulfills Anti-Money Laundering and Combating the Financing of Terrorism (AML/CFT) requirements; using the voting user account of claim 1 without using registered mobile devices.
